(19) United States
(12) Patent Application Publication
(10) Pub. No.: US 2008/0075498 A1
(43) Pub. Date: Mar. 27, 2008

(54) Color image forming device

(75) Inventor: Hidehiko Kojo, Osaka (JP)

Correspondence Address: JORDAN AND HAMBURG LLP, 122 EAST 42ND STREET, SUITE 4000, NEW YORK, NY, 10168, US

(73) Assignee: KYOCERA MITA CORPORATION, Chuo-ku (JP)

(21) Appl. No.: 11/903,831

(22) Filed: Sep. 24, 2007

(30) Foreign Application Priority Data
Sep. 27, 2006 (JP) 2006-261793

(51) Int. Cl. G03G 15/00

(52) U.S. Cl. 399/85

(57) ABSTRACT

To provide a color image forming device that is capable of reducing the power consumption and unnecessary consumption of toners without deteriorating the productivity of a printing job.

Provided is a color image forming device which includes a power control part 150 which controls switching of a mode from a normal power supply mode to a power saving mode when a power-saving shift time T1 or T2 has passed during a standby state; a printing mode switching part 101f for switching a single-color printing mode and a full-color printing mode; and an initial printing mode setting part 101g for setting an initial printing mode at the time of supplying a power source to one of the printing modes, wherein a different power-saving shift time T1 or T2 is set depending on the printing mode that is initially set by the initial printing mode setting part 101g.

### BACKGROUND OF THE INVENTION

1. Field of the Invention

The present invention relates to a color image forming device which includes: a power control part which controls switching of a mode from a normal power supply mode to a power saving mode when a power-saving shift time has passed during a standby state; a printing mode switching part for switching a single-color printing mode and a full-color printing mode; and an initial printing mode setting part for setting an initial printing mode at the time of supplying a power source to one of the modes.

2. Description of the Related Art

Conventionally, there has been proposed an image forming device which: forms an electrostatic latent image by irradiating modulated light beams on a surface of an image carrier that is uniformly charged, based on output image data; forms a toner image by developing the formed electrostatic latent image; and thermally fixes the toner image that is transferred to a recording paper.

Recently, there is a spread of a color image forming device which: forms electrostatic latent images that correspond to each color component of cyan, magenta, yellow, and black in order on a photoreceptor to form toner images of each color component with corresponding color toners; performs primary transfer by superimposing those toner images of each color component on a belt-type intermediate transfer unit, for example; and performs thermal fixation after performing secondary transfer further on a recording paper.

The above-described color image forming device is not only capable of printing/outputting a full-color image but also capable of printing/outputting a monotone image such as a black-and-white image. The above-described color image forming device therefore includes: a printing mode switching part for switching a full-color printing mode for printing/outputting a full-color image and a single-color printing mode for printing/outputting a monotone image. There is also such a type in the color image forming device, which includes a fixing device in which a first fixing temperature for the full-color printing is set higher than a second fixing temperature for the single-color printing in order to secure the fixing performance at the time of executing the full-color printing.

That is, with the above-described color image forming device, it is necessary to increase the temperature for an amount of the difference between the first fixing temperature and the second fixing temperature. Thus, when the full-color printing mode is selected, a longer time is required to increase the temperature of the fixing device than a case where the single-color printing mode is selected, thereby delaying printing processing for that time. This causes not only a problem of deteriorating the productivity but also a problem of consuming a large quantity of electricity.

Further, normally, an image forming device executes a calibration control of an image forming part in parallel to a temperature-increase control of the fixing device at a startup time and/or when returning to a normal power supply mode from a power saving mode.

The calibration is a control for performing a density correction of each color component based on the printing modes (whether it is the single-color printing mode or the full-color printing mode). Compared to the single-color printing mode, the full-color printing mode requires a longer time to execute the calibration.

Depending on the devices, it requires about five minutes for the calibration under the full-color printing mode. Therefore, there is not only a problem of deteriorating the productivity regarding the printing job because of a delay in the printing processing but also problems of the power consumption for the calibration and consumption of the toners of each color component.

That is, after the device shifts to the power saving mode, the time for returning to the full-color printing mode requires a longer time than the time for returning to the single-color printing mode.

Japanese Unexamined Patent Publication No. 2005-244829 proposes an image forming device which includes: a calibration mechanism that adjusts a printer engine for achieving color output; retaining means for retaining main mode information that indicates which processing (whether color output processing or monochrome output processing) is taken as the main mode; and control means that switches whether or not to execute calibration processing by the calibration mechanism when starting up the device in accordance with the main mode information retained in the retaining means.

When the main mode information indicates the monochrome processing and an operation state is in a power saving mode, upon accepting a job of the monochrome processing, the image forming device preferentially performs printing of that job after returning to a normal mode, and executes calibration in full-color printing thereafter. Alternatively, the device does not execute the calibration that corresponds to the full-color printing until it accepts a job of the full-color printing after returning to the normal mode. Through the above, the deterioration in the productivity of the single-color printing caused due to an execution of the calibration is improved.

It is also considered to increase the probability of achieving an execution of a printing job immediately without executing the calibration through uniformly setting a length of time for shifting to the power saving mode, which causes the deterioration in the productivity of the printing job when returning to the normal mode. In that case, however, there is such a problem that the power consumption increases during a standby state until the printing job is requested.

### SUMMARY OF THE INVENTION

In view of the above-described problems, it is an object of the present invention to provide a color image forming device that is capable of reducing the power consumption without causing the deterioration in the productivity of a printing job.

In order to achieve a foregoing object, the color image forming device according to the present invention is a color image forming device which includes: a power control part which controls a switching of a mode from a normal power supply mode to a power saving mode when a power-saving shift time passes during a standby state; a printing mode switching part for switching a color printing mode and a full-color printing mode; and an initial printing mode setting part for setting an initial printing mode at a time of supplying a power source to one of the printing modes, wherein a different power-saving shift time is set depending on the printing mode that is initially set by the initial printing mode setting part.

It is preferable for the power-saving shift time to be set such that a first shift time for shifting from the single-color printing mode to the power saving mode is set shorter than a second shift time for shifting from the full-color printing mode to the power saving mode.

Further, it is preferable for the device to include a power-saving shift time setting part which is capable of setting the power-saving shift time in a range where the first shift time becomes shorter than the second shift time.

### BRIEF DESCRIPTION OF THE DRAWINGS

FIG. 1 is a functional block diagram of each control part;

FIG. 2 is an illustration showing an external appearance of a digital copying machine;

FIG. 3 is an illustration for describing an operation part;

FIG. 4A is an illustration for describing a power-saving shift time setting screen;

FIG. 4B is an illustration for describing a screen for requesting a re-input of the power-saving shift time;

FIG. 5 is an illustration used for describing an image output part;

FIG. 6A is a flowchart used for describing switching of a power mode executed in the digital copying machine; and

FIG. 6B is a flowchart used for describing switching of a power mode executed in the digital copying machine.

### DESCRIPTION OF THE PREFERRED EMBODIMENTS

Described hereinafter is an embodiment of an electrophotography-type digital copying machine that is an example of a color image forming device to which the present invention is applied.

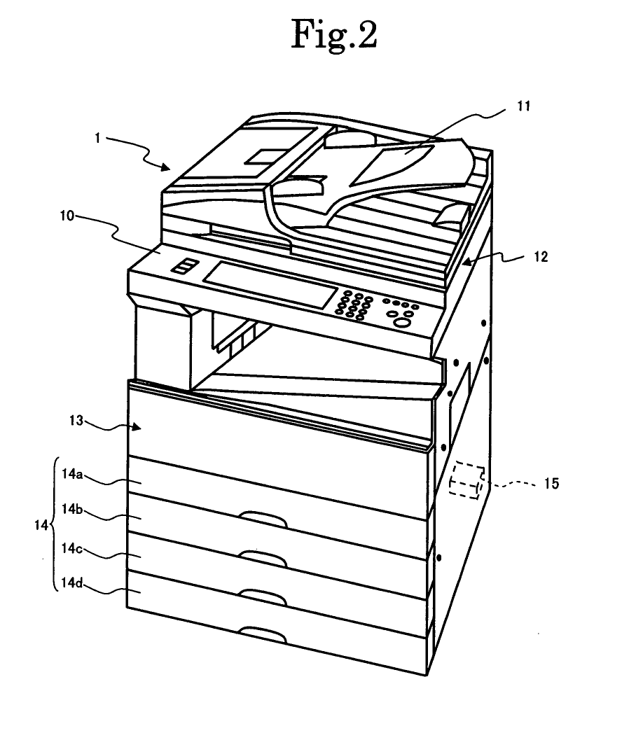

As shown in FIG. 2, a digital copying machine 1 includes: an operation part 10 where a color display part, hardware keys, and the like are arranged; an image readout part 12 which reads a series of manuscripts that are set in a manuscript loading part 11 and converts those to electronic data, and generates output image data by applying prescribed processing thereto; an electrophotography-type image output part 13 which forms and outputs a toner image on a paper based on the output image data generated by the image readout part 12; paper feeding cassettes 14 that accommodate recording papers that are recording members to which the formed toner image is transferred; and a system control part 15 for performing a general control of the digital copying machine 1.

The digital copying machine 1 includes two power modes; one is a normal power supply mode capable of printing based on a requested printing job, and the other is a power saving mode which suppresses the power consumption by suppressing the power supply to each part during a standby state where there is no request for a printing job.

The digital copying machine 1 is constituted to automatically switch to the power saving mode when it stays in a standby state for a prescribed time with the normal power supply mode without a request for a printing job, and to automatically switch to the normal power supply mode when the operation part 10 is operated under the power saving mode so as to perform calibration and to increase the temperature of the fixing device.

Further, the digital copying machine 1 includes two printing modes; one is a single-color printing mode with which the printing job that is executed under the normal power supply mode executes monochrome printing, and the other is a full-color printing mode with which full-color printing is executed. The digital copying device 1 is so constituted that each printing mode can be switched by a user.

Furthermore, it is constituted to be able to set the printing mode at the time of a startup of the digital copying machine 1 and/or when returning to the normal power supply mode from the power saving mode as an initial printing mode.

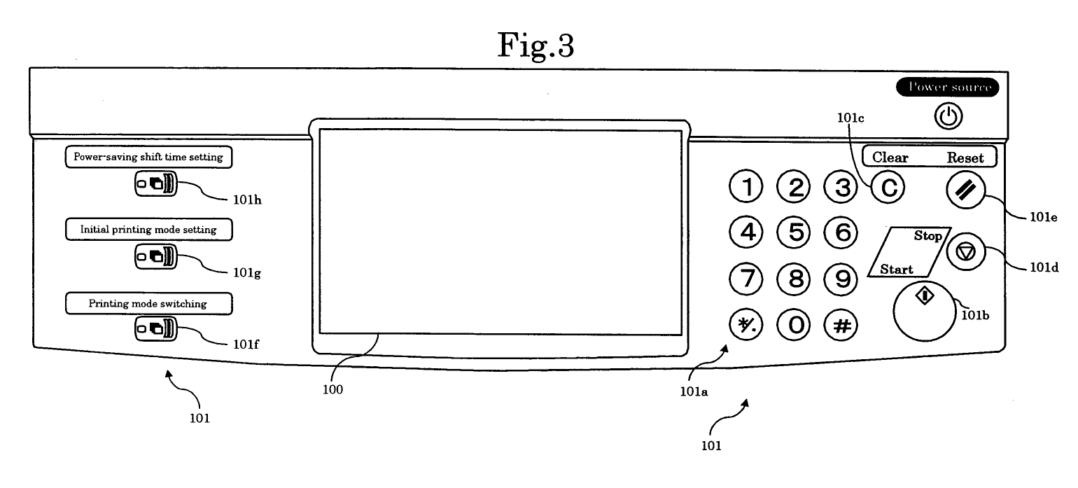

As shown in FIG. 3, the operation part 10 is provided with a touch-panel type color display part 100 where an operation screen, on which a plurality of menu selection keys for designating copying conditions are arranged as software keys, is displayed; hardware keys 101 such as a start key for starting up an image forming action, numerical value input keys and the like for inputting numerical values; and the like.

Provided as the hardware keys 101 are: numerical value input keys 101a for setting the number of prints and the like; a start key 101b for starting printing; a clear key 101c for clearing the printing job; a stop key 101d for forcibly ending the printing; a reset key 101e for resetting an already-set printing condition and the like; a printing mode switching key 101f for switching the printing mode of the digital copying machine 1 to either the single-color printing mode that executes the job with a single color or the full-color printing mode that executes the job with full colors; an initial printing mode setting key 101g for setting the initial printing mode at the time of supplying a power source and/or when returning from the power saving mode; a power-saving shift time setting key 101h for setting the power-saving shift time; and the like.

The printing mode switching key 101f functions as a printing mode switching part of the present invention. Every time the user presses the key 101f, the single-color printing mode and the full-color switching mode are switched.

The initial printing mode setting key 101g functions as an initial printing mode setting part of the present invention. When the user presses the key 101g, the printing mode set at the point where the key is pressed is set as the initial printing mode at the time of supplying the power source and/or when returning from the power saving mode. That is, the digital copying machine 1 operates with the printing mode that is set as the initial printing mode, at the time of supplying the power source and/or when returning from the power saving mode.

The power-saving shift time setting key 101h functions as a power-saving shift time setting part of the present invention. When the user presses the key 101h, a power-saving shift time setting screen 100a for setting the power-saving shift time (the time for shifting from the normal power supply mode to the power saving mode during a standby state) is displayed on the color display part 100. When the user inputs the desired power-saving shift time, the power-saving shift time is set as an input value.

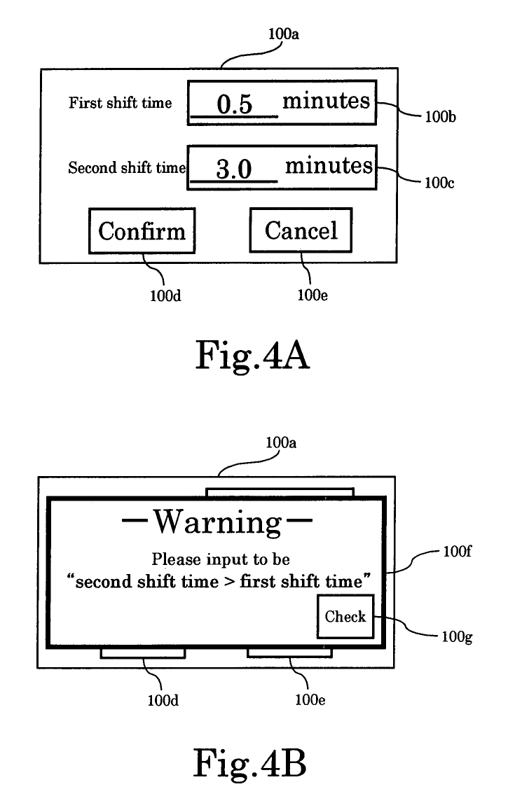

As shown in FIG. 4A, displayed on the power-saving shift time setting screen 100a are: a first shift time setting frame 100b for setting a first shift time in which the mode is shifted from the single-color printing mode to the power saving mode; a second shift time setting frame 100c for setting second shift time in which the mode is shifted from the full-color printing mode to the power saving mode; a “confirm” button 100d for confirming an input; and a “cancel” button 100e for canceling an input and un-displaying the screen 100a.

Input values by a unit of “0.1” minute is displayed on each of the frames 100b and 100c of the power-saving shift time setting screen 100a through an input operation of the numerical value input keys 101a, and the power-saving shift time is set by operating the “confirm” button 100d.

Regarding the power-saving shift time, it is so constituted that the first shift time can be set to fall within a range that is shorter than the second shift time. If the second shift time is inputted to be the same as the first shift time or the second shift time is inputted to be shorter than the first shift time, the screen 100f for requesting a re-input is displayed as a warning by being superimposed on the power-saving shift time setting screen 100a, as shown in FIG. 4B. This screen 100f is canceled when a “check” button 100g is pressed, and it becomes possible to input the power-saving shift time through the power-saving shift time setting screen 100a that is displayed again. That is, this constitutes a power-saving shift time setting part that is capable of setting the power-saving shift time within a range where the first shift time becomes shorter than the second shift time.

The image readout part 12 includes: the manuscript loading part 11 on which manuscripts are loaded; a manuscript feeding part for feeding the manuscript that is loaded on the manuscript loading part 11; a CCD linear sensor for reading out an image of the manuscript that is fed by the manuscript feeding part; an image generating part which generates output image data by applying image processing on the manuscript image that is read out by the CCD linear sensor; and the like.

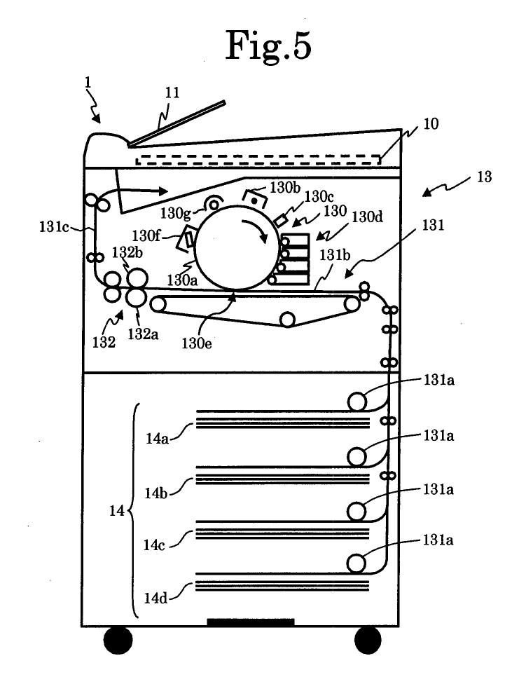

As shown in FIG. 5, the image output part 13 includes: an image forming part 130 which forms a toner image on a photoreceptor 130a based on the output image data that is generated by the image generating part; a transporting part 131 for transporting an accommodated recording paper from the paper feeding cassette 14; a fixing part 132 which fixes the toner image transferred on the recording paper by performing heat fusion; and the like.

The transporting part 131 includes: a paper feeding/transporting part 131a which transports the recording papers one by one from the paper feeding cassette 14 where the recording papers of different sizes are accommodated; a transferring/transporting part 131b which transports the fed recording paper to a transferring part 130e, and transports the recording paper on which the toner image is transferred towards the fixing part 132; and a paper discharge part 131c which discharges the recording paper that has passed through the fixing part 132 in a facedown manner. A transporting roller is provided to each part.

The image forming part 130 includes: the photoreceptor 130a; and the following parts that are arranged around the photoreceptor 130a in an orderly manner. The orderly arranged parts are: an electricity charger 130b which corona-charges the surface uniformly; a print head 130c which forms an electrostatic latent image by exposing the charged photoreceptor 130a; a developing part 130d which develops an image by statically attaching the toner on the electrostatic latent image formed on the photoreceptor 130a; a transferring part 130e for transferring the toner image on the recording paper; a cleaning part 130f for eliminating the toner remained after the transfer; and a static eliminating lamp 130g which eliminates and equalizes potential remained on the surface of the photoreceptor 130a. The developing part 130d are provided with four colors (cyan, magenta, yellow, and black) of developing blocks so that it is possible to generate a color image.

When the mode returns from the power saving mode to the normal power supply mode, calibration is executed in the image forming part 130 for adjusting a bias voltage that is applied between the photoreceptor 130a and the developing part 130d, a transfer bias voltage that is applied between the photoreceptor 130a and the transferring part 130e, and the like, in order to set the toner density of each color component to a prescribed toner density. Calibration is also carried out at the time of a startup where the power source is supplied, and the device operates with the printing mode that is set to the initial printing mode, at the time of the startup and/or when returning from the power saving mode.

The calibration executed in the image forming part 130 at the time of the startup and/or when returning from the power saving mode will be described in detail. When the initial printing mode is set as the single-color printing mode, the calibration is executed only on the black developing block. Meanwhile, the calibration is executed on the developing blocks of the whole color components, when the initial printing mode is set as the full-color printing mode.

Further, when the initial printing mode that is being set as the single-color printing mode is switched to the full-color printing mode, the calibration is executed for the developing blocks of the whole color components. When the initial printing mode that is being set as the full-color printing mode is switched to the single-color printing mode, there is no calibration executed and the values obtained when the calibration is executed for the developing blocks of the whole color components are employed.

The bias voltage and the transfer bias voltage set by a calibration action are maintained until the digital copying machine 1 shifts to the power saving mode from the normal power supply mode.

The calibration transfers a toner image that is constituted with a test pattern on a recording paper by the transferring part 130e, detects the density of the toner image with a density sensor (not shown), adjusts the bias voltage and the transfer bias voltage by feeding back the density detected by the density sensor, and adjusts the toner densities of each color component to prescribed densities.

The fixing part 132 is constituted with a pressing roller 132a and a fixing roller 132b, which fixes the toner image by performing heat fusion on the toner image through pressure-welding and transporting the recording paper on which the toner image is transferred with the pressure roller 132a and the fixing roller 132b (serving as a fixing device) which is heated to a prescribed temperature. A heater for heating the fixing roller 132b is provided to an inside of the fixing roller 132b, and a thermistor element for detecting the temperature of the fixing roller 132b is arranged on a prescribed surface part of the fixing roller 132b.

During an operation under the power saving mode, the fixing part 132 suppresses the power consumption by stopping or suppressing the power supplied to the heater that is provided inside the fixing roller 132b. Meanwhile, at the time of the startup and/or when returning from the power saving mode to the normal power supply mode, a supply of the power to the heater is restarted or a prescribed power is supplied to increase the temperature of the fixing roller 132b to the prescribed temperature by the heater, and the prescribed temperature is maintained until the mode is shifted to the power saving mode.

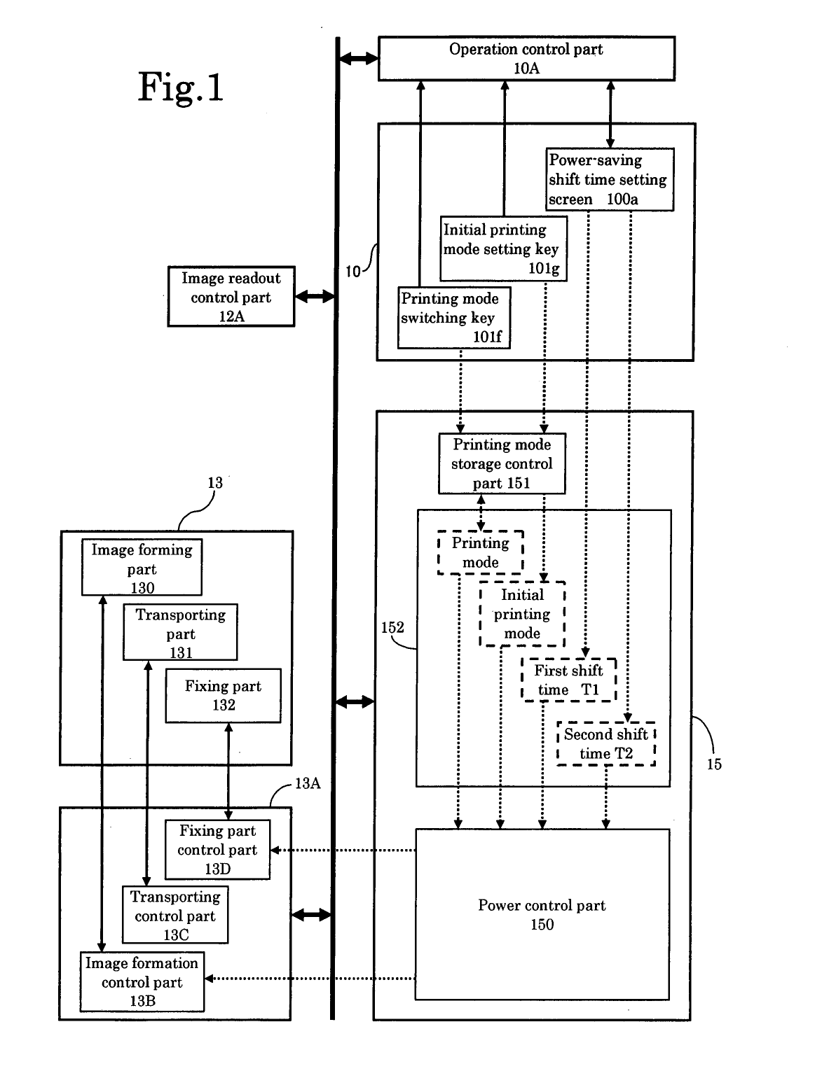

As shown in FIG. 1, a control part of the above-described digital copying device 1 includes: an operation control part 10A for controlling input/output signals of the operation part 10; an image readout control part 12A for controlling the image readout part 12; an image output control part 13A for controlling the image output part 13; and a system control part 15 which manages executions of an copying action and the like by controlling timings of each of the control parts 10A, 12A, and 13A described above. Each of the control parts 10A, 12A, 13A, and the system control part 15 is provided with a CPU, a ROM to which an operation program executed by the CPU is stored, and the like.

Among the functional blocks executed by each of the control parts 10A, 12A, 13A and the system control part 15, the parts that relate to the present invention will be described hereinafter.

The operation control part 10A outputs, to the system control part 15: a first shift time T1 and a second shift time T2, which are inputted as power-saving shift times through the power-saving shift time setting screen 100a that is displayed on the display part 100 of the operation part 10; a printing mode that is set in the digital copying machine 1 by pressing the printing mode setting switching key 101f; and a fact that there is a pressing action on the initial printing mode setting key 101g when the key 101g is pressed.

The image output control part 13A is constituted with: an image formation control part 13B for controlling the image forming part 130; a transporting control part 13C for controlling the transporting part 131; and a fixing part control part 13D for controlling the fixing part 132.

Upon receiving a request from the system control part 15 based on the power mode and the printing mode which are set in the digital copying machine 1, each of the control parts 13B, 13C, and 13D control to operate the respective parts with the power saving mode or the normal power supply mode in accordance with the request. Further, under the operation of the normal power supply mode, each of the control parts 13B, 13C, and 13D control to operate the respective parts with either the single-color printing mode or the full-color printing mode.

When there is a request to operate under the initial printing mode from the system control part 15 while the digital copying machine 1 is under the power saving mode, the image formation control part 13B returns the image forming part 130 to the normal power supply mode, and executes calibration that corresponds to the initial printing mode.

Further, when there is a request to operate under the full-color printing mode from the system control part 15 while the digital copying machine 1 is in operation under the normal power supply mode and the set printing mode is the single-color printing mode, the image formation control part 13B controls to operate the image forming part 130 with the full-color printing mode after performing calibration that corresponds to the full-color printing mode.

Furthermore, when there is a request from the system control part 15 to shift to the power saving mode while the digital copying machine 1 is in operation under the normal power supply mode, regardless of the currently selected printing mode, the image formation control part 13B shifts the image forming part 130 to the power saving mode.

When there is a request to operate under the normal power supply mode from the system control part 15 while the digital copying machine 1 is under the power saving mode, the fixing part control part 13D increases the temperature of the fixing roller 132b to a prescribed temperature, and maintains the prescribed temperature thereafter. When there is a request to operate under the power saving mode from the system control part 15 while the digital copying machine 1 is under the normal power supply mode, the fixing part control part 13D stops the supply of the power to the heater of the fixing roller 132b or decreases the controlled temperature.

The system control part 15 is provided with: a power control part 150 which makes a request to each of the control parts 10A, 12A, and 13A to operate each of the corresponding parts with either the normal power supply mode or the power saving mode; a printing mode storage control part 151 for storing the printing mode and the initial printing mode outputted from the operation control part 10A to a storage part; and a storage part 152 that is constituted with a RAM or the like provided inside.

Upon receiving the printing mode from the operation control part 10A, the printing mode storage control part 151 stores the printing mode to the storage part 152. Further, upon receiving from the operation control part 10A that the initial printing mode setting key 101g is being pressed, the printing mode storage control part 151 stores the printing mode, which is stored in the storage part 152, to the storage part 152 as the initial printing mode.

The storage part 152 stores the first shift time T1 and the second shift time T2 outputted from the operation control part 10A, as well as the printing mode and the initial printing mode inputted from the printing mode storage control part 151.

Under a state where the digital copying machine 1 is in the normal power supply mode and the printing mode stored in the storage part 152 is the single-color printing mode, when the printing mode is rewritten to the full-color printing mode, the system control part 15 requests each of the control parts 10A, 12A, and 13A to perform calibration on each of the corresponding parts with the full-color printing mode. Even if the printing mode is rewritten to the single-color printing mode when the printing mode stored in the storage part 152 is the full-color printing mode, calibration with the single-color printing mode is not carried out and each of the parts is operated with the single-color printing mode.

Further, when the first shift time T1 stored in the storage part 152 has passed during a standby state where there is no request for a printing job under a state where the digital copying machine 1 is in the normal power supply mode and the initial printing mode is the single-color printing mode, or when the second shift time T2 stored in the storage part 152 has passed during the standby state where there is no request for a printing job under a state where the initial printing mode is the full-color printing mode, the power control part 150 requests each of the control parts 10A, 12A, and 13A to shift each of the corresponding parts to the power saving mode.

Furthermore, when the operation part 10 is operated under a state where the digital copying machine 1 is in the power saving mode, the power control part 150 upon receiving an output from the operation control part 10A requests each of the control parts 10A, 12A, and 13A to shift each of the corresponding parts to the normal power supply mode and to operate each part with the initial printing mode that is stored in the storage part 152.

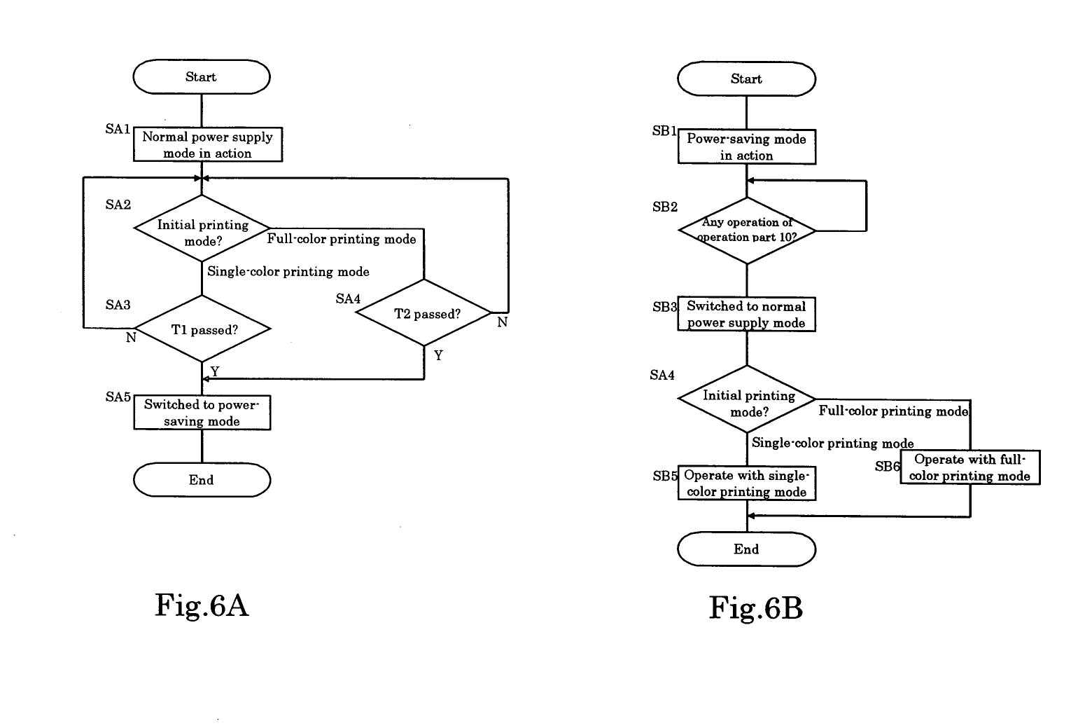

Hereinafter, switching of the mode in the digital copying machine 1 from the normal power supply mode to the power saving mode will be described by referring to a chart shown in FIG. 6A.

Under a state where the digital copying machine 1 is in the normal power supply mode (SA1) and the initial printing mode is the single-color printing mode (SA2), when the first shift time T1 has passed during the standby state (SA3), the mode is switched to the power saving mode (SA5). Under a state where the initial printing mode is the full-color printing mode (SA2), when the second shift time T2 has passed during the standby state (SA4), the mode is switched to the power saving mode (SA5).

Hereinafter, switching of the mode in the digital copying machine 1 from the power saving mode to the normal power supply mode will be described by referring to a chart shown in FIG. 6B.

Under a state where the digital copying machine 1 is in the power saving mode (SB1), when the operation part 10 is operated (SB2), the mode is switched to the normal power supply mode (SB3). When the initial printing mode is the single-color printing mode (SB4), the digital copying machine 1 operates with the single-color printing mode (SB5). When the initial printing mode is the full-color printing mode (SB4), the digital copying machine 1 operates with the full-color printing mode (SB6).

As described above, the color image forming device according to the present invention is provided with: the power control part which controls to switch the mode from the normal power supply mode to the power saving mode after the power-saving shift time has passed during the standby state; the printing mode switching part which switches the single-color printing mode and the full-color printing mode; and the initial printing mode setting part which sets the initial printing mode at the time of supplying the power source to either one of the printing modes. The color image forming device of the present invention is so constituted that a different power-saving shift time is set in accordance with the printing mode that is set initially by the initial printing mode setting part.

Therefore, it is possible to reduce the power consumption without causing deterioration in the productivity of the printing job.

Further, regarding the power-saving shift time, the first shift time for shifting from the single-color printing mode to the power saving mode is set shorter than the second shift time for shifting from the full-color printing mode to the power saving mode. Therefore, for the single-color printing mode that requires only a short time to be shifted to a printable state from a power-saving state, the power can be saved without deteriorating the productivity even if the power-saving shift time is set shorter. For the full-color printing mode that requires a long time to be shifted to a printable state from the power-saving state, deterioration of the productivity can be prevented by preventing the shift to the power saving mode through setting the power-saving shift time longer.

Furthermore, through maintaining the full-color printing mode, it is possible to reduce the number of calibration executed at the time of returning from the power saving mode for suppressing the power consumption for the calibration so as to decrease the consumption of color toners that are more expensive than a black toner.

Another embodiment will be described hereinafter.

The foregoing embodiment has been described by referring to a case of a digital copying machine as an image forming device to which the present invention is applied. However, the present invention can be applied not only to the digital copying machine but also to a printer, a fax machine, a composite machine, and the like, which are capable of performing color printing.

The foregoing embodiment has been described by referring to the structure where the power-saving shift time setting screen 100a is displayed on the color display part 100, and the power-saving shift time is set in such a range that the first shift time T1 becomes shorter than the second shift time T2. However, it is possible to employ a structure where the first shift time T1 and the second shift time T2 are set in advance as fixed times.

The foregoing embodiment is structured to include the printing mode switching key 101f as the printing mode switching part, and the initial printing mode setting key 101g as the initial printing mode setting part. However, it is possible to employ a structure where the printing mode switching part and the initial printing mode setting part are arranged as software keys on the operation screen that is displayed on the color display part 100.

It is to be understood that the foregoing embodiments are merely presented as a preferred embodiment of the present invention, and it is obvious to those skilled in the art that various modifications and changes in the specific structures of each component are possible without departing from the spirit and the scope of the present invention.

What is claimed is:

1. A color image forming device, comprising:
a power control part which controls switching of a mode from a normal power supply mode to a power saving mode when a power-saving shift time has passed during a standby state;
a printing mode switching part for switching a single-color printing mode and a full-color printing mode; and
an initial printing mode setting part for setting an initial printing mode at a time of supplying a power source to one of the printing modes, wherein
a different power-saving shift time is set depending on the printing mode that is initially set by the initial printing mode setting part.

2. The color image forming device according to claim 1, wherein, regarding the power-saving shift time, a first shift time for shifting from the single-color printing mode to the power saving mode is set shorter than a second shift time for shifting from the full-color printing mode to the power saving mode.

3. The color image forming device according to claim 2, comprising a power-saving shift time setting part which is capable of setting the power-saving shift time in a range where the first shift time becomes shorter than the second shift time.

4. The color image forming device according to claim 3, wherein the power-saving shift time setting part is so constituted that the first shift time and the second shift time can be set through a same power-saving shift time setting screen.

5. The color image forming device according to claim 3, wherein:
the power-saving shift time setting part is so constituted that the first shift time and the second shift time can be set through a same power-saving shift time setting screen; and
a warning is displayed when the first shift time is inputted and set to be longer than the second shift time.
